(19) United States
(12) Patent Application Publication
(10) Pub. No.: US 2025/0382169 A1
(43) Pub. Date: Dec. 18, 2025

(54) NOZZLES AND BEVERAGE MACHINES

(71) Applicants: Marmon Foodservice Technologies, Inc., Osseo, MN (US); Cornelius (Tianjin) Co., Ltd., Tianjin (CN)

(72) Inventors: Brian Mastro, Des Plaines, IL (US); Yulong Liu, Tianjin (CN); Kebin Liu, Tianjin (CN); Peiyuan Yang, Tianjin (CN); Tinghao Chen, Tianjin (CN); Qi Zheng, Tianjin (CN)

(73) Assignees: Marmon Foodservice Technologies, Inc., Osseo, MN (US); Cornelius (Tianjin) Co., Ltd., Tianjin, OT (CN)

(21) Appl. No.: 19/242,546

(22) Filed: Jun. 18, 2025

(30) Foreign Application Priority Data
Jun. 18, 2024 (CN) 202421395311.8

(51) Int. Cl. B67D 1/12

(52) U.S. Cl. CPC B67D 1/1272

(57) ABSTRACT

A nozzle includes a nozzle body and a flow restrictor. The nozzle body has an inlet and an outlet. The flow restrictor includes a housing and a diffusion tube that is sleeved into the housing, the housing is connected to the inlet end of the nozzle body and extends into the nozzle body. The diffusion tube includes at least one communication port. An annular gap is defined between the housing and the diffusion tube.

### CROSS-REFERENCE TO RELATED APPLICATIONS

The present application claims priority of Chinese Patent Application No. 202421395311.8, filed on Jun. 18, 2024, and which granted on May 23, 2025, as patent number ZL202421395311.8, the contents of which is hereby incorporated by reference in entirety.

### FIELD OF THE DISCLOSURE

The present disclosure relates to the beverage machine field, more specifically relates to a nozzle and a beverage machine.

### BACKGROUND

Carbonated beverages are beverages that contain carbon dioxide gas dissolved in water. This gas dissolves in the water. When the gas releases from the water, bubbles are formed which makes the drink frothy and refreshing. In order to dissolve carbon dioxide in water to produce carbonated water, it is often necessary to supply carbon dioxide at a high pressure. In the process of dispensing the carbonated water, high pressure will produce jetting, and the carbon dioxide will prematurely break out from the water producing a large number of bubbles and expansion, which will lead to high flow rate, excessive foam, splashing, and low carbonization degree of the dispensed beverage, among other problems.

Therefore, it is necessary to provide a nozzle and beverage machine to at least partially solve the above problems.

### BRIEF DISCLOSURE

A series of concepts in simplified forms are introduced which will then be further elaborated upon. The utility model content part of the present invention is not meant to attempt to define the key features and necessary technical features of the technical solution claimed for protection, much less is it necessary means an attempt to determine the scope of protection of the technical solution for which protection is claimed.

A nozzle is disclosed herein which includes a nozzle body, wherein the nozzle body has a connected inlet end and an outlet end. A flow limiting piece includes a shell and a diffusion tube sleeved into the shell, the shell bodies are connected to the inlet end and socketed to the nozzle body, the end of the diffusion pipe sleeved to the shell is closed, the pipe wall close to the closed end of the diffusion pipe is provided with a connecting port, and the connecting port is penetrated along the radial direction of the diffusion pipe; Among them, an annular gap is defined between the shell and the diffusion tube, the annular gap is communicated with the outlet end, and the diffusion tube is connected with the annular gap through the connecting port.

In one aspect disclosed herein, the nozzle creates a laminar flow state of the carbonated water when flowing in the annular gap. This reduces the generation of eddy currents and turbulence in the flow of water which thereby slows down the flow of carbonated water through the nozzle. This slowed and laminar flow reduces the rate of gas release from the carbonated water, which helps to increase the carbonization degree of carbonated water, making the beverage more efferving and refreshing, in line with consumer demand for carbonated beverages.

In examples, the radial width of at least part of the annular clearance is 0.04-0.4 mm and/or the axial length of the annular clearance is 2-30 mm.

A diffusion pipe may penetrate the housing and extend into the nozzle body. An end of the diffusion pipe may be provided with a cone. The cone may be located within the nozzle body. Radial dimensions of the top end of the cone portion are smaller than the radial dimensions of the bottom end of the cone portion, and the radial size of the bottom end of the cone portion is greater than the inner diameter of the shell. An angle between the bus bar and the axis of the cone part may between 15-75 degrees. The diffusion pipe may further include a cylinder portion, which is connected to a bottom end of the cone portion, and the cylindrical portion is spaced apart from an inner wall of the nozzle body.

The nozzle body may include a tapering section, tapering along the axial direction of the nozzle body, the tapering section is located between the flow limiting piece and the outlet end, and the tapering section is in the flow limiting section. A cross-sectional area in the direction of the piece to the outlet end is gradually reduced. An inner wall of the nozzle body is provided with a groove extending circumferentially.

An interface may be included, the interface connected to the outlet end, and a central axis of the interface may be not co-linear with the central axis of the nozzle body. The connecting plate may also be connected to the housing, or the connecting plate may be connected simultaneously to the housing and the diffusion tube.

An inner pipe may be connected to one side of the flow limiting piece towards the outlet end, a gas outlet is arranged at the end of the inner pipe close to the flow limiting piece, and the inside of the nozzle body is communicated with the outside world through the gas outlet.

### BRIEF DESCRIPTION OF THE DRAWINGS

The following drawings of the embodiments of the present invention are hereby used as part of the present invention for the understanding of the present invention but are not limiting on the scope of the present disclosure or of the claims herein. The accompanying drawings show embodiments of the present invention and their descriptions to explain the principles of the present invention. In the accompanying drawings:

FIG. 1 is a perspective view of an example of a nozzle.

FIG. 2 a partial cross-sectional view of the nozzle of FIG. 1.

FIG. 3 is a schematic diagram of the flow direction in the nozzle of FIG. 1.

FIG. 4 is the three-dimensional exploded view of the nozzle of FIG. 1.

FIG. 5 is an isolated view of an example of a diffusion tube.

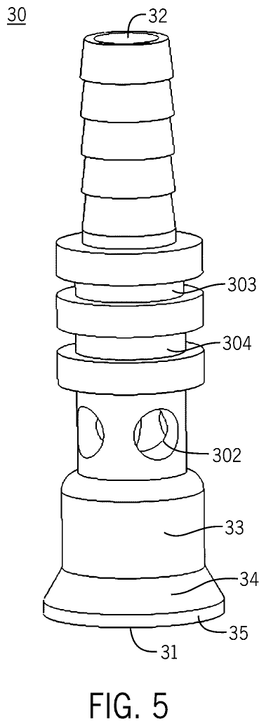

FIG. 6 is a cross-sectional isolated view of the nozzle body.

FIG. 7 is a partial cross-sectional view of an example of the nozzle.

FIG. 8 is a perspective view of an example of a nozzle.

FIG. 9 is a schematic view of an example of the nozzle in a beverage dispensing machine.

### BRIEF DESCRIPTION OF REFERENCE NUMERALS OF THE DRAWINGS

### Explanation of Reference Symbols

100: Nozzle
10: Nozzle body
101: Groove
11: Inlet
12: Outlet
13: Tapering section
14: Open interior
15: Flow restrictor
16: Interior surface
20: Housing
21: Inlet end
22: Outlet end
23: Lip
24: Inner surface
201: Connecting slot
30: Diffusion tube
301: Annular gap
302: Communication port
303: Connecting slot
304: Groove
31: Closed end
32: Open end
33: Boss portion
34: Transition cone
35: Cylinder portion
36: Bore
37: Terminus
38: Wall
39: Outer Surface
40: Sealing ring
50: Inner tube
501: Gas outlet
502: Open end
60: Interface
70: Clip
80: Beverage dispenser

### DETAILED DISCLOSURE

In the following description, a great deal of specific detail is given to provide a more thorough understanding of the disclosure. However, a person of ordinary skill in the art will further recognize from the present disclosure that examples disclosed herein may be implemented with more or fewer details than as described. In order to avoid confusion with the embodiment of the present invention, some technical features commonly known in the art are not described.

In this document, ordinal words such as “first” and “second” referenced in the present invention are merely identifications and do not have any other meaning, such as a specific order. And, for example, the term “first part” itself does not imply the existence of a “second part,” the term “second part” does not in itself imply the existence of the “first part.”

In this article, “up,” “down,” “front,” “back,” “left,” “right,” etc., are only used to indicate the relative positional relationship between the related parts, and not to define the absolute position of these related parts.

It should be noted that this article is used to describe the directional terms of the beverage machine, such as “vertical,” “directional.”

Up, down, above, below, etc., are relative to the beverage dispenser in an upright position. Understandably, the beverage dispenser is placed and used in an upright position.

For the purposes of this document, “equal,” “same,” etc., are not strictly mathematical and/or geometric limitations, but also include errors that are understandable to those skilled in the art and are permissible for manufacture or use, etc.

Unless otherwise noted, the numerical range in this article includes not only the entire range within its two endpoints.

The illustrative embodiments according are now described in more detail with reference to the accompanying drawings. However, these examples can be implemented in a number of different forms and should not be construed as confined to the embodiments described here. It should be understood that these embodiments are provided in order to make the disclosure of the present invention thorough and complete, and to construct these exemplary embodiments.

A nozzle 100 includes a nozzle body 10. The nozzle body 10 has an inlet 11 and an outlet 12 and an open interior 14 between the inlet 11 and the outlet 12. A flow restrictor 15 includes a housing 20 and the diffusion tube 30 socketed into the housing 20. The housing 20 is exemplarily generally cylindrical and extends from an inlet end 21 to an outlet end 22. The housing 20 is in turn connected to the inlet 11 of the nozzle body. The diffusion tube 30 is received in the housing 20. The diffusion tube 30 is at least partially radially interior of the housing to form an annular gap 301 between the diffusion tube 30 and the housing 20. The diffusion tube 30 extends from an open end 32 to which a source of carbonated water, or a similar beverage including carbonated water, is connected, and a closed end 31 positioned within the housing 20. The diffusion tube 30 includes a bore 36 that extends axially from the open end 32 in the direction of the closed end 31. The bore 36 ends in terminus 37, and one or more communication ports 302 extend through a wall 38 of the diffusion tube 30 at the terminus 37. The communication ports 302 exemplarily extend radially outward from the axis of the diffusion tube 30.

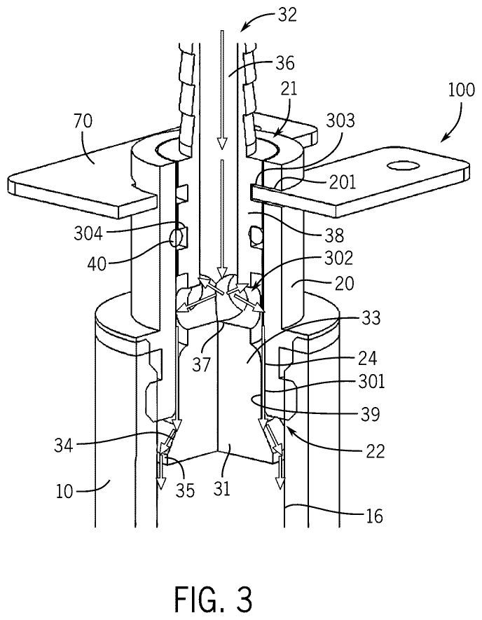

More specifically, the annular gap 301 is formed between the closed end 31 of the diffusion tube 30 and the outlet end 22 of the housing 20. As described herein the annular gap 301 fluidly connects the at least one communication port 302 to the open interior 14 of the nozzle body 10. The open interior 14, as described herein communicates with the outlet end 12. Through this arrangement, as described herein, carbonated water can flow from the open end 32 through the nozzle 100 to the outlet 12 this is exemplarily depicted in FIG. 3 by arrows 110.

When carbonated water flows through the annular gap 301, the pressure of the carbonated water as it flows in the annular gap 301 decreases slowly and helps the carbonated water flowing through in the annular gap 301 to exhibit a laminar flow state. That is, the fluid as it flows in the direction of arrows 110 through the annular gap 301 in a streamline flow with exemplary parallel layers. Laminar flow reduces the generation of vortex and turbulence, thereby slowing down the flow rate of carbonated water through the nozzle and reducing the rate of gas release from the carbonated water. This increases the carbonation remaining within the carbonated water, improving the carbonization degree of carbonated water.

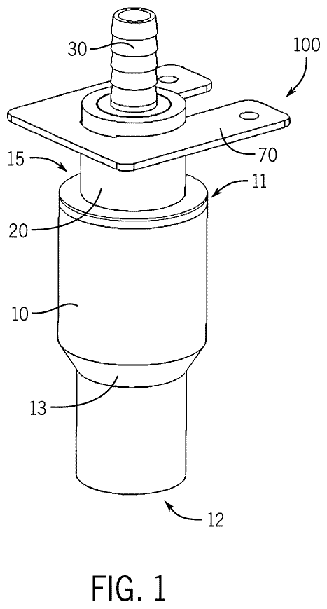

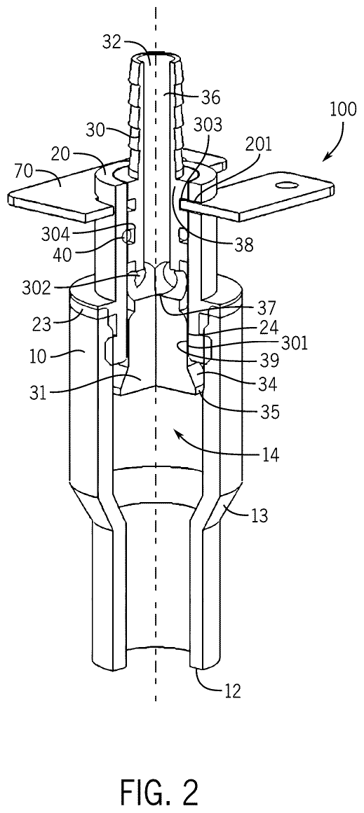

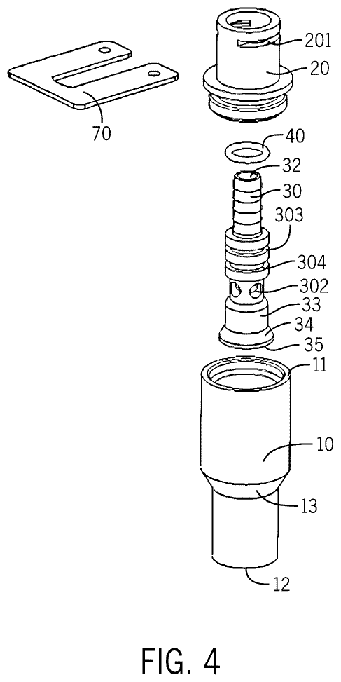

Referring to FIGS. 1-4, and 7, the nozzle body 10 is constructed as a hollow tubular structure with an open interior 14 between the inlet 11 and the outlet 12. Housing 20 is constructed as a hollow tubular structure between the inlet end 21 and the outlet end 22. The housing 20 at the outlet end 22 is socketed into nozzle body 10 at the inlet 11. The diffusion tube 30 is socketed to the housing 20 so that at least a portion of the diffusion tube 30 is radially interior of the nozzle body 10 and at least a portion of the diffusion tube 30 is radially interior of the housing 20. In a further example, as will be detailed herein, the diffusion tube 30 may be socketed into the outlet end 22 of the housing 20 and may exemplarily extend longitudinally outside of one or both of the inlet end 21 and outlet end 22 of the housing 20 when the diffusion tube 30 is socketed into the housing 20. The flow restrictor 15 provided by the combined diffusion tube 30 and housing 20 assembly may then be partially inserted into the nozzle body 10 from the inlet 11. Seals, exemplarily provided by one or more o-rings form liquid-tight connections between coaxial portions of the nozzle body 10, housing 20, and diffusion tube 30. The seals further provide overall stability and tightness of the assembly of the nozzle 100. Optionally, between the nozzle body 10 and the housing 20 and/or a sealing ring 40 is arranged between the housing 20 and the diffusion tube 30. The sealing ring 40 may be seated within a groove 304 in the diffusion tube 30. Optionally, socket connections can be made by other means, including but not limited to threaded connections and snap-in connections.

The housing 20 further includes an annular lip 23 that extends radially outward from an outer lumen of the housing 20. When the outlet end 22 of the housing is inserted within the inlet 11 of the nozzle body 10, the annular lip 23 engages the nozzle body 10 at the inlet 11 to define a furthest extent in which the outlet end 22 can extend into the nozzle body 10. The inlet end 21 thus extends away from the annular lip 23 exterior of the nozzle body 10.

The diffusion tube 30 is installed at the end of the carbonated water distribution system and thus is fluidly connected to a source of carbonated water. The diffusion tube 30 is constructed as a hollow tubular structure, extending between the open end 32 and the closed end in an axial direction. The open end 32 of the diffusion tube 30 facilitates the fluid connection to the source of carbonated water. Sealing ring 40 is positioned within a groove 304 at a position between the diffusion tube 30 and the housing 20 at a position between the annular gap 301 and the inlet end 21 of the housing 20.

With the diffusion tube 30 inserted at least partially within the housing 20, carbonated water flowing into the open end 32 fusion tube 30 is able to flow out to the annular gap 301 through the communication port 302, which helps to form a laminar flow state and reduce gas release rate, increase the carbonization degree of carbonated water. The flow of fluid slows down due to the frictional resistance to the water against the terminus 37 and through the communication ports 302 and further between outer surface 39 of the closed end 31 and the inner surface 24 of the housing 20. The fluid passes through the communication port 302 Enter the annular gap 301, the total velocity of the fluid will be limited and the flow direction will be integrated to form a laminar flow fluid.

Optionally, outer surface of the diffusion tube 30 is radially inset at the region of the communication ports 302. This forms a comparatively enlarged portion of the annular gap 301. A boss portion 33 necks out towards the inner surface 24 of the housing 20 and forming the narrow of the annular gap 301. The boss portion 33 exemplarily has a larger radial dimension than a radial dimension of the diffusion tube 30 at the at least one communication port 302. This enlarged portion forms a buffer space for the outflow fluid through the communication ports 302 and reduces the impact and turbulence of the outflow of the fluid and to direct the fluid in the narrow portion of the annular gap. This helps to maintain the stability and uniformity of the fluid.

Optionally, the diffusion tube 30 is includes a boss portion 33, exemplarily as described above. The setting of the boss portion 33 is possible to a certain extent to direct the carbonated water into the annular gap 301 into the laminar flow state. In examples, the outer surface 39 of the boss portion 33 is parallel to the inner surface 24 of the housing 20.

In a still further example, a transition cone 34 extends radially outward from the outer surface 39 and/or the boss portion 33. The transition cone 34 is located in the axial direction towards the outlet 12 of the outlet end 22 of the housing 20. The transition cone 34 extends radially outwards towards an interior surface 16 of the nozzle body 10. The transition cone 34 and/or the angle of the transition cone helps to guide the carbonated water from the annular gap 301 out of the outlet end 22 into the open interior of the nozzle body 10. This smooth transition reduces the turbulence and vortex that can occur during the transition of the fluid.

In examples, the radial width of the annular gap 301 is between 0.04-0.4 mm. In still further examples, the radial width of the annular gap is between 0.05-0.15 mm. The axial length of the annular gap is exemplarily 2-30 mm.

Through experimentation, the inventors have found that annular gaps 301 within these ranges promotes a uniform flow of carbonated water inside the nozzle, reduces possible vortex and turbulence, and optimizes the flow of carbonated water inside the nozzle. In still further examples, it will be recognized that the dimensions of the annular gap and/or the dimensions and/or numbers of the communication ports 302 may be better suited for dispense of carbonated water of different levels of carbonation. As will be described in further detail herein, a plurality of diffusion tubes 30, housings 20, and/or nozzle bodies 10 available for replacement to tune the nozzle to dispense carbonated water of different carbonation levels.

The following experimental data was obtained from non-limiting examples of nozzles as disclosed herein, with carbonation expressed in volumes where one volume is one liter of CO2 at STP dissolved in one liter of liquid. As supported by the table below, the nozzle 100 disclosed herein is able to dispense carbonated water with a carbonation level of about or above 4 and with flow rates above 30 ml/s or above 60 ml/s.

| CO2 | Flow rate | |
|---|---|---|
| pressure | (ml/s) | Carbonation |
| 75 | 39 | 4.1 |
| 75 | 31.8 | 4.4 |
| 65 | 31.8 | 4.4 |
| 55 | 31.8 | 4.2 |
| 75 | 60 | 4.0 |
| 75 | 65 | 3.9 |

As previously noted, the carbonated water flows from the diffusion tube 30 through the one or more communication ports 302 and into the annular gap 301 between the outer surface 39 of the diffusion tube 30 and the inner surface 24 of the housing 20. The outer surface 39 may further be defined by a boss portion 33. When the carbonated water flows beyond the inner surface 24 of the housing 20, the flow is exemplarily directed by a transition cone 34 which directs the flow radially outwards towards the interior surface 16 of the nozzle body 10. The angle of the transition cone 34 may exemplarily be between 15-75 degrees. The carbonated water flowing over the transition cone 34 exemplarily continues at generally the same angle as the transition cone 34 by inertia until the flow hits the interior surface 16 of the nozzle body 10. Control of the transition cone 34 angle between the 15-75 degree range will thus control the ejection angle of the fluid off of the transition cone 34.

The downstream end of the diffusion tube 30 includes a cylinder portion 35 extending from the transition cone 34. The cylinder portion 35 further extends radially interior of the interior surface 16 of the nozzle body 10 to continue the restriction of the fluid flow which causes the fluid flow to flow along the interior surface 16 of the nozzle body 10 towards the outlet 12.

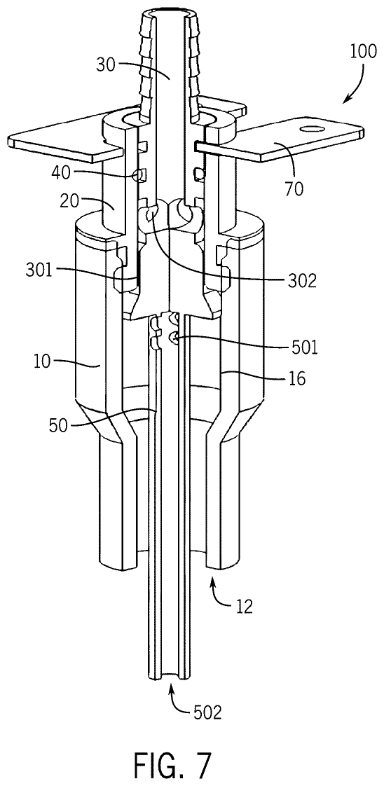

In an example, and as shown in FIG. 7, the nozzle 100 may also include an inner tube 50 connected to the closed end of the diffusion tube 30, and which exemplarily extends within the nozzle body 10 and out of the nozzle body 10 through the outlet 12. In an example, the inner tube 50 extends from the cylinder portion 35 or from the transition cone 34 if no cylinder is portion 35 is present. The inner tube 50 is provided with a gas outlet 501 which includes one or more holes. The inner tube 50 is hollow from an open end 502 to the gas outlet. The inner tube 50 provides a gas connection between outside the nozzle 100 into the open interior 14 of the nozzle body 10. As can be seen from the foregoing, the fluid follows transition cone 34 and/or cylinder portion 35 to flow along the interior surface 16 of the nozzle body 10. This forms an annular flow region where the carbon dioxide escaping during the flow of the fluid is collected in the void of the open interior 14 below the closed end 31 in the region about the gas outlet 501. The accumulated released carbon dioxide is able to be expelled outside the nozzle 100 through the inner tube 50. This further lowers pressure within the nozzle which in turn reduces flow rate at the outlet end 12. In addition, the setting of the inner tube 50 can guide the direction of fluid flow and reduce spatter.

The nozzle body 10 also includes a tapering section 13. Along the axial direction of the nozzle body 10, the tapering section 13 is located at the end of the diffusion tube 30 and prior to the outlet 12. The tapering section 13 radially reduces the cross-sectional area of the open interior 14 of the nozzle body 10 in the direction towards the outlet 12. The tapering section 13 exemplarily concentrates the fluid flow at the nozzle outlet 12.

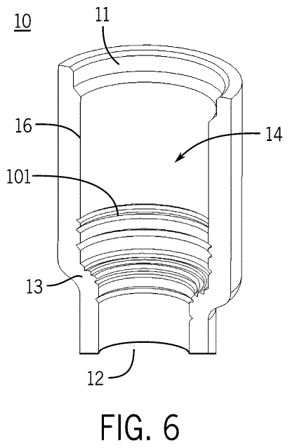

Referring to FIG. 6, the interior surface 16 of the nozzle body 10 is provided with at least one groove 101 extending circumferentially. Optionally, the at least one groove 101 is set on the interior surface 16 of the tapering section 13, the upper part of the tapering section 13, and/or the lower part of the tapering section 13. The at least one groove 101 in the interior surface 16 further serves to slow the flow of fluid.

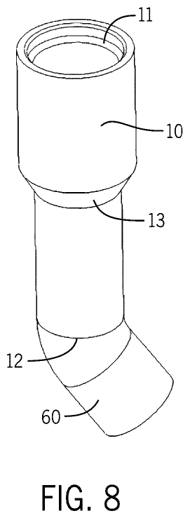

With reference to FIG. 8, the nozzle 100 further comprises an interface 60, the interface 60 is connected to the nozzle body 10 outlet end 12, and the central axis of the interface 60 is connected to the nozzle body 10 The central axis of the nozzle body 10 is not collinear with the central axis of the interface 60. Optionally, interface 60 is molded in one piece with the nozzle body 10. Optionally, the nozzle body 10 outlet end 12 is an inclined setting.

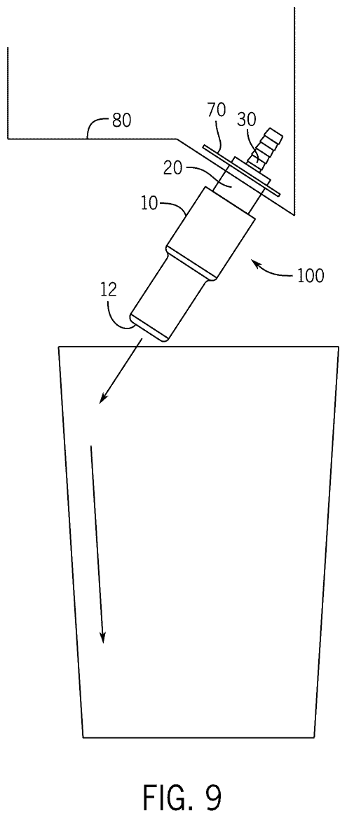

In another example, the interface 60 is curved tubular and therefore directs the flow of fluid against the side wall of the cup, this further promotes a smooth filling of the cup, avoiding splashing and reducing carbonation break out. FIG. 9 also depicts an example wherein the nozzle body 10 is straight, but the entire nozzle 100 is angled relative to the point of dispense to provide an angled stream of the dispensed carbonated water. Returning to Going back to FIGS. 1-4, the housing 20 is provided with a connecting slot 201. The connecting slot 201 may extend through a portion of the wall of the housing 20 at the inlet end 21 or in the direction of the inlet end 21 from the lip 23. The connecting slot 201 may extend about the circumference of the housing 20 or partially through a portion of the circumference of the housing 20. As exemplarily shown with reference to FIGS. 1 and 9, the connecting slot 201 receives a clip 70, to secure the nozzle 100 to the structure or frame of a beverage dispensing machine 80.

It will be recognized that the connecting slot 201 may extend partially into the wall of the housing 20 or fully through the wall of the housing 20. In an example wherein the connecting slot 201 extends through the wall of the housing 20, the diffusion tube 30 may be similarly provided with a connecting slot 303. When the diffusion tube 30 is properly seated within the housing 20, the connecting slot 303 is in alignment with the connecting slot 201 both rotationally and longitudinally about the axis of the diffusion tube 30. With the connecting slot 201 aligned with the connecting slot 303, the clip 70 may be concurrently received in both of the connecting slot 201 and the connecting slot 303 to provide further securement between these components. This helps to stabilize the overall position of the nozzle, and further ensure that the diffusion tube 30 does not move axially with respect to housing 20. The groove 304 which exemplarily retains the sealing ring is exemplarily positioned towards the closed end 31 of the diffusion tube 30 from the connecting slot 303, to further provide the sealing effect downstream of the slots 201, 303 forming the connection with the clip 70.

As previously noted, dimensions and arrangements of the nozzle 100 as described herein may be suited for particular flow rates and/or carbonation levels. Therefore, a further advantage of the clip 70 and arrangement thereof is improved accessibility to change between nozzles 100 or diffusion tubes 30 within the nozzle 100 to match the structure of the nozzle 100 with the intended carbonation level and/or flow rate. In an example multiple diffusion tubes 30 and or nozzles 100 may be available, each dimensioned and arranged within the above disclosure for various carbonation levels and/or flow rates. In still further examples, diffusion tubes 30 and or nozzles 100 may be available based upon whether the dispensed carbonated water is combined with any other flavor or other additives to produce a beverage. Such additives may change the viscosity and/or other properties of the beverage, and resulting adjustments to the structures and dimensions as described herein. If the beverage, flow rate, or carbonation level to be dispensed from the beverage dispenser is changed, then the nozzle 100 may be serviced in the field by replacement of the nozzle 100 or diffusion tube 30 to provide conditions for dispense of the intended beverage and beverage properties.

Optionally, the diffusion tube 30, the housing 20 and the nozzle body 10 may be constructed as a single molding. Optionally, the diffusion tube 30, the housing 20, the nozzle body 10 can be made of metal or plastic materials. Optionally, the material may contain inorganic silver nano-antimicrobial components.

As noted above, the disclosed nozzle 100 may be incorporated into a beverage machine. Such beverage machine may be capable of dispensing carbonated water or other beverages of which carbonated water is an ingredient.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A nozzle for a beverage dispenser comprising:
a nozzle body, wherein the nozzle body has a an inlet end and an outlet end; and
a flow restrictor comprises a housing and a diffusion tube sleeved into the housing, the housing connected to the inlet end of the nozzle body, the diffusion tube extending from an open end to a closed end, with the closed end at least partially within the housing and at least one communication port at the closed end extending radially through the diffusion tube and an annular gap is defined between the housing and the closed end of the diffusion tube, the annular gap defining a flow path from the at least one communication port to the outlet end of the nozzle body.

2. The nozzle of claim 1, wherein a radial width of at least part of the annular gap is between 0.04-0.4 mm and an axial length of the annular gap is between 2-30 mm.

3. The nozzle of claim 1, wherein the diffusion tube penetrates through the housing and extends into the nozzle body; the closed end of the diffusion tube is provided with a transition cone, the transition cone is separated from an inner wall of the nozzle body, the radial size of an upstream end of the transition cone is smaller than a radial size of a downstream end of the transition cone, and the radial size of the downstream end of the transition cone is greater than an inner diameter of the housing.

4. The nozzle of claim 3, wherein the transition cone extends at an angle between 15-75 degrees.

5. The nozzle according to claim 3, wherein the diffusion tube further comprises a cylinder portion, the cylinder portion is extends from the downstream end of the transition cone, and the cylinder portion is spaced apart from the inner wall of the nozzle body.

6. The nozzle of claim 1, wherein the nozzle body comprises a tapering section, along an axial direction of the nozzle body, and the tapering section is positioned at downstream of the diffusion tube, and the tapering section reduces a cross-sectional area of an opening within the nozzle body.

7. The nozzle of claim 1, wherein an inner wall of the nozzle body is provided with at least one groove extending circumferentially.

8. The nozzle of claim 1, further comprises an interface, the interface is connected to the outlet end, and a central axis of the interface is not collinear with a central axis of the nozzle body.

9. The nozzle of claim 1, further comprising a connecting clip, the connecting clip is connected to the housing or the connecting clip is simultaneously connected to the housing and the diffusion tube.

10. The nozzle of claim 1, further comprising an inner tube, the inner tube is extends downstream of the closed end of the diffusion tube towards the outlet end, and the inner tube comprises at least one gas outlet and gas communication is provided outside of the nozzle through the at least one gas outlet and the inner tube.

11. A nozzle for a beverage dispensing machine, the nozzle comprising:
a nozzle body extending from an inlet to an outlet and having an open interior;
a housing having an inlet end and an outlet end, the outlet end of the housing configured to be secured within the inlet end of the nozzle body; and
a diffusion tube sleeved within the housing wherein an open end of the diffusion tube extends exterior of the inlet end of the housing and a closed end of the diffusion tube extends exterior of the outlet end of the housing, the diffusion tube defining a bore that ends at the closed end in at least one communication port radially extending through the diffusion tube and wherein an annular gap is defined between an outer surface of the closed end and an inner surface of the housing, wherein the annular gap is configured to produce laminar flow of a fluid therethrough, and a transition cone extends downstream of the housing and radially outwards towards an interior surface of the nozzle body.

12. The nozzle of claim 11, further comprising at least one slot through the housing and at least one slot into the diffusion tube, wherein the at least one slot through the housing and the at least one slot into the diffusion tube are configured to align and jointly receive a clip, the clip configured to secure the housing and the diffusion tube from coaxial translation or rotation.

13. The nozzle of claim 11, further comprising an inner tube extending downstream from the closed end of the diffusion tube and extending out of the outlet of the nozzle body, wherein the inner tube comprises an open end exterior of the nozzle body and at least one gas outlet an end opposite the open end.

14. A beverage dispensing machine comprising:
a frame configured to provide structure to the beverage dispensing machine;
a source of a dispensed beverage; and
a nozzle fluidly connected to the source, the nozzle comprising:
a nozzle body extending from an inlet to an outlet and having an open interior;
a housing having an inlet end and an outlet end, the outlet end of the housing configured to be secured within the inlet end of the nozzle body; and
a diffusion tube sleeved within the housing wherein an open end of the diffusion tube extends exterior of the inlet end of the housing and a closed end of the diffusion tube extends exterior of the outlet end of the housing, the diffusion tube defining a bore that ends at the closed end in at least one communication port radially extending through the diffusion tube and wherein an annular gap is defined between an outer surface of the closed end and an inner surface of the housing, wherein the annular gap is configured to produce laminar flow of a fluid therethrough, and a transition cone extends downstream of the housing and radially outwards towards an interior surface of the nozzle body.

15. The beverage dispenser of claim 14 wherein the diffusion tube is one diffusion tube of a plurality of diffusion tubes, and wherein the plurality of diffusion tubes are interchangeable within the beverage dispenser to coordinate with a flow rate and/or carbonation level of the dispensed beverage.

16. The beverage dispensing machine of claim 15 wherein the nozzle is one nozzle of a plurality of nozzles and each diffusion tube of the plurality of diffusion tubes is within a respective nozzle of a plurality of nozzles, and wherein interchange of the diffusion tube comprises interchange of the nozzle form the plurality of nozzles.

17. The beverage dispensing machine of claim 15 wherein the plurality of diffusion tubes each comprise different cross-sectional areas of the at least one communication port.

18. The beverage dispensing machine of claim 15 wherein the plurality of diffusion tubes each comprise different radial widths of the annular gap.

19. The beverage dispensing machine of claim 15 wherein the plurality of diffusion tubes each comprise different angles of the transition cone.

20. The beverage dispensing machine of claim 15, further comprising at least one slot through the housing and at least one slot into the diffusion tube, wherein the at least one slot through the housing and the at least one slot into the diffusion tube are configured to align and jointly receive a clip, the clip configured to secure the housing and diffusion tube from coaxial translation or rotation and to secure the nozzle to the frame, wherein the clip is accessible for manual interchange between the plurality of diffusion tubes.
